(19) United States
(12) Patent Application Publication
(10) Pub. No.: US 2014/0260112 A1
(43) Pub. Date: Sep. 18, 2014

(54) CRYOVIAL HANDLING APPARATUS

(71) Applicant: Cellara, Madison, WI (US)

(72) Inventors: Reidar Aamotsbakken, Madison, WI (US); Charlie Heidenreich, McFarland, WI (US); Kevin Conard, Madison, WI (US); Gregg Matter, Sussex, WI (US)

(21) Appl. No.: 14/207,115

(22) Filed: Mar. 12, 2014

Related U.S. Application Data
(60) Provisional application No. 61/784,678, filed on Mar. 14, 2013.

(51) Int. Cl. B65B 43/40; A01N 1/02; B65B 5/08

(52) U.S. Cl. CPC B65B 43/40; B65B 5/08; A01N 1/0284
USPC 53/475; 53/167

(57) ABSTRACT

An apparatus for the simultaneous capping and uncapping of a plurality of vial assemblies, each of the vial assemblies including a vial body and a vial cap, the apparatus comprising a base, a cryogenic insert detachably coupled to the base and defining at least a first aperture about a first axis and a second aperture about a second axis, the first aperture configured to receive a first vial body, and the second aperture configured to receive a second vial body, the cryogenic insert including a cryogenic media, a first drive member engaging the first vial body for rotation about the first axis, a second drive member engaging the second vial body for rotation about the second axis, and a cap gripper assembly selectively coupled to the base, the cap gripper assembly selectively holding a first vial cap in substantial alignment with the first axis and a second vial cap in substantial alignment with the second axis, such that the first drive member may selectively couple the first vial body to the first vial cap, and the second drive member may couple the second vial body to the second vial cap.

### CROSS-REFERENCE TO RELATED APPLICATIONS

This claims priority to U.S. Patent Application No. 61/784,678, filed on Mar. 14, 2013, the entire contents of which are fully incorporated herein by reference.

### FIELD OF THE INVENTION

The present invention relates to a device designed for biological sample processing of biological cells for cryopreservation.

More specifically, this invention relates to improved tools and methods for cryopreservation of biological samples in cryovials where a controlled rate of freezing is called for in the cryopreservation process.

### BACKGROUND

Cryopreservation of cells involves suspending a predetermined amount of cells in freeze media (standard is addition of 10% dimethyl sulfoxide (DMSO)), usually into a disposable plastic tube (e.g., a 50 mL suspension tube). The cells are then filled into cryovials (e.g., a 2 mL, or 5 mL disposable plastic vial volumes) manually by uncapping each cryovial by hand, pipetting a volume of cells/media into the cryovial and manually capping the cryovial.

Cryovials are transferred to a controlled freeze rate container such as, for example, a Nalgene® Mr. Frosty®, as they are filled, and the container is placed in a −80° C. freezer once all cryovials are in place. A typical controlled freeze rate container, such as a Mr. Frosty®, can contain 18 cryovials, though other controlled freeze rate containers may contain more or fewer cryovials. During the fill process, a continuous manual re-pipetting of the volume in the suspension tube is performed to keep the cells suspended uniformly throughout the fill process. This can be laborious for the technician and create inefficiencies due to inconsistent pipetting, mishandling of the cells, or inaccurate addition of other media thereby endangering the cells for the cryopreservation process.

Timing and temperature control is extremely important during the cryopreservation process as cells degrade rapidly while in the freeze media prior to freezing. The freeze media is somewhat toxic to the cells, but is necessary to preserve cell viability during the freezing process and in the frozen state. A controlled rate of freezing of 1° C./min is generally called out for all cells and some other biologics to prevent crystallization and osmotic shock inside the cells, and the Mr. Frosty® isopropyl alcohol filled controlled freeze rate container is the standard freeze container used in both industry and academia. This manual process for cryopreservation is the status quo due to its proven success in numerous white papers. Studies have shown that cell viability post-thaw can be kept over 90% by keeping temperature during the freeze and thaw process below 4° C. and keeping the cells' exposure to freeze media outside the frozen state to a minimum. Cell viability deteriorates rapidly when cells are exposed to freeze media above 4° C. and is directly related to temperature and time of exposure. From a given batch of cells, the amount of cells suspended and filled into each cryovial is determined empirically by each lab based on prior recorded viability rates and adjusted so each cryovial is guaranteed to contain a predetermined number of viable cells upon thawing. A “normal” viability used in yield calculations for cryopreservation of human stem cells is 70%.

The current manual cryopreservation filling method results in a yield per batch of cells that is heavily dependent on the technique of the technicians performing the cryopreservation process. Exposure to temperature above 4° C. and time of such exposure directly affects the final yield of cells viable after thawing. Any process improvement to control temperature and decrease time of exposure to freeze media at temperatures above freezing will increase percentage cell viability and thus result in a higher yield of vials from a given batch of grown cells.

Current products in the marketplace designed for uncapping and capping cryovials do not fit well into the established cryopreservation process. They are large and heavy, making removal of these products from the biosafety cabinet after each use not feasible. They do not control the temperature of the cryovials during the filling process, and they do not fit the process flow when using a controlled freeze rate container. Space in biosafety cabinets must be made available for other work between each time a cryopreservation process has been performed. Accordingly, there is a need in the art for a device that more efficiently and consistently prepares biological cells for cryopreservation processes.

### SUMMARY OF THE INVENTION

In one embodiment, the invention provides an apparatus for the simultaneous capping and uncapping of a plurality of vial assemblies. Each of the vial assemblies includes a vial body and a vial cap. The apparatus includes a base and a cryogenic insert detachably coupled to the base and defining at least a first aperture about a first axis and a second aperture about a second axis. The first aperture is configured to receive a first vial body, and the second aperture configured to receive a second vial body. The cryogenic insert includes a cryogenic media. A first drive member engages the first vial body for rotation about the first axis. A second drive member engages the second vial body for rotation about the second axis. A cap gripper assembly is selectively coupled to the base. The cap gripper assembly selectively holds a first vial cap in substantial alignment with the first axis and a second vial cap in substantial alignment with the second axis, such that the first drive member may selectively couple the first vial body to the first vial cap, and the second drive member may couple the second vial body to the second vial cap.

In another embodiment the invention provides a method of handling a plurality of vial assemblies within a capping apparatus. Each vial assembly has a vial body and a vial cap. The capping apparatus includes a base assembly, a cap gripper assembly, and a cryogenic insert including a plurality of receptacles. The cryogenic insert is coupled to the base assembly. Each of the vial assemblies is placed within one of the receptacles. The cap gripper assembly is coupled to the base assembly. The vial cap of each vial assembly is gripped with the cap gripper assembly. Each of the vial bodies is rotated to separate the vial bodies from the respective vial cap. The cap gripper assembly is separated from the base assembly, with the cap gripper assembly retaining the plurality of vial caps.

In yet another embodiment the invention provides an apparatus for the simultaneous capping and uncapping of a plurality of vial assemblies. Each of the vial assemblies includes a vial body and a vial cap. A base defines at least a first aperture about a first axis and a second aperture about a second axis. The first aperture is configured to receive a first vial body, and the second aperture is configured to receive a second vial body. A first drive member engages the first vial body for rotation about the first axis. A second drive member engages the second vial body for rotation about the second axis. A cap gripper assembly is selectively coupled to the base. The cap gripper assembly selectively holds a first vial cap in substantial alignment with the first axis and a second vial cap in substantial alignment with the second axis, such that the first drive member may selectively couple the first vial body to the first vial cap, and the second drive member may couple the second vial body to the second vial cap.

In still yet another embodiment the invention provides a method of handling a plurality of vial assemblies within a capping apparatus. Each vial assembly has a vial body and a vial cap and the capping apparatus includes a base assembly, a cap gripper assembly, a cryogenic insert, and a plurality of drive members rotatably coupled to the cryogenic insert. The method includes coupling the cryogenic insert to the base assembly. Each of the vial assemblies is placed within one of the drive members. The cap gripper assembly is coupled to the base assembly. The vial cap of each vial assembly is gripped with the cap gripper assembly. Each of the vial bodies is rotated to separate the vial bodies from the respective vial cap. The cap gripper assembly is separated from the base assembly, with the cap gripper assembly retaining the plurality of vial caps.

Other aspects of the invention will become apparent by consideration of the detailed description and accompanying drawings.

### BRIEF DESCRIPTION OF THE DRAWINGS

FIG. 1 is a perspective view of a vial handling apparatus.

FIG. 2 is a perspective view of a vial assembly.

FIG. 3 is an electrical block diagram of the vial handling apparatus of FIG. 1.

FIG. 4 is a cross sectional view of the vial handling apparatus of FIG. 1 along section line 4-4 of FIG. 1.

FIG. 5 is an exploded view of the vial handling apparatus of FIG. 1.

FIG. 6 is a perspective view of a vial drive member of the vial handling apparatus of FIG. 1.

FIG. 7 is another perspective view of the vial drive member of FIG. 6.

FIG. 8 is a perspective view of a vial motor of the vial handling apparatus.

FIG. 9 is an exploded view of a cap gripper assembly of the vial handling apparatus of FIG. 1.

FIG. 10 is an alternative exploded view of the cap gripper assembly of FIG. 9.

FIG. 11 is a perspective view of a cam disc of the cap gripper assembly of FIG. 9.

### DETAILED DESCRIPTION

The present invention is directed to a device that provides for simultaneous capping and uncapping of a plurality of vial assemblies for improved cell viability and process efficiency. The device uses of a cryogenic insert that defines vial apertures to maintain biological samples at a temperature of about 0 to about 4° C. in combination with individual vial motors that turn the individual vials and allow for automation of the capping of the vials. This device provides an efficient and temperature controlled manner to cryopreserve any biological composition, cell or particle and reduces degradation during the process of filling prior to freezing. The automation of the device further provides a lab technician the ability to perform consistent preparation of the biological material such as pipetting, or other handling of the cells to provide the best opportunity for maximizing the cryopreservation process.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Referring to the FIG. 1, a vial handling apparatus 10 is shown. The vial handling apparatus 10 is configured for handling biological sample vial assemblies, such as, for example, 0.5 mL, 1.0 mL, 1.5 mL, 2.0 mL, 4.0 mL, 5.0 mL or other size cryovials. The vial handling apparatus may be configured to handle the preferred volumetric size between 2.0 mls to 5.0 mls for cryopreservation vials.

FIG. 2 illustrates an exemplary sample vial assembly 14, including a vial body 18 and a vial cap 22. The vial body 18 includes a substantially cylindrical wall 26 extending between a first end 30 and a second end 34. The vial body defines external threads at the first end 30 for engagement with corresponding internal threads defined by the vial cap 22. The second end 34 includes a plurality of fin members 38 which, together, define an external spline 42.

FIG. 3 is an electrical block diagram of the vial handling apparatus 14. A controller 46 includes a microcontroller 50 coupled to a printed circuit board (PCB) 54. The controller 46 also includes timers and memory modules. A programming port 56 is in communication with the microcontroller 50 for updating firmware and other tasks requiring communication with the microcontroller 50.

The controller 46 receives power from a power module 58 that is coupled to the PCB 54. The power module 58 includes a 3.7V LiPoly battery pack 62 rated at 1100 mAh. The battery pack 62 is rechargeable using a battery charger 66 connected to a DC power source 70. The battery charger 66 may be connected to the battery pack 62 via a USB port or other connection type. In other embodiments, the power module may include other types and sizes of rechargeable battery cells (e.g., Li-Ion or Ni—Cd). In still other embodiments, the power module may include a plurality of alkaline or other non-rechargeable cells and/or an AC to DC converter and a step-down transformer. A low battery light emitting diode (LED) 74 provides indication of a low battery charge state.

Eighteen vial motors 78 are connected to the PCB 54 via a dual H-bridge motor driver 82 that is in communication with the microcontroller 50. Other embodiments of the invention may include more or fewer vial motors (e.g., one, two, three, four, or more vial motors). Each of the vial motors 78 may be, for example, a geared, brushed DC precious metal motor. Each vial motor 78 has a torque rating of approximately 1.5 to 3.5 inch-pounds and is operable in two directions. Actuation time for each vial motor 78 is approximately 3 seconds. Average motor current for each vial motor is measured and received by the microcontroller 50. A pair of vial LEDs 86 is associated with each vial motor, for a total of eighteen vial LED pairs 86. Each vial LED pair 86 includes a red LED 90 and a green LED 94. The red LED 90 may illuminate, for example, if the respective vial motor 78 continues to operate beyond a specified actuation time or exceeds a specified motor current. The green LED 94 may illuminate, for example, when the respective vial motor 18 completes actuation within a specified time.

A cap gripper motor 98 is connected to the PCB 54 via an H-bridge motor driver 104. The cap gripper motor 98 has a torque rating from approximately 25 inch-pounds to approximately 75 inch-pounds. The cap gripper motor 98 is operational in a single direction and has an actuation time of approximately one second. Average motor current of the cap gripper motor 98 is measured and controlled with the microcontroller 50. A single pair of cap LEDs 108 is associated with the cap gripper motor 98. The cap LED pair 108 includes a red LED 112 and a green LED 116. The red LED 112 may illuminate, for example, if the cap gripper motor 98 continues to operate beyond a specified actuation time or exceeds a specified motor current. The green LED 116 may illuminate, for example, when the cap gripper motor 98 completes actuation within a specified time.

In addition to the eighteen pairs of vial LEDs 86 and the cap LED pair 108, a central LED pair 120 provides indication to the user of overall normal or abnormal operation of the vial drive motors 78 and cap gripper motor 98. The central LED pair 120 includes a red LED 124 and a green LED 128. The red LED 124 may indicate, for example, faulty operation of one or more of the eighteen vial motors 78 or the cap gripper motor 98. The green LED 128 indicates overall normal operation. In addition to the visual indication provided by the LED pairs 86, 108, and 120, an audible alarm 130 provides additional indication to the user of abnormal or faulty operation. The audible alarm 130 may sound, for example, when any red LED (e.g., 90, 112, 124) is illuminated.

Four switches are coupled to the PCB 54 and in communication with the microcontroller 50. A cover switch 132 closes when a cap gripper assembly 136 is properly seated on a base assembly 140 (FIG. 1). Referring again to FIG. 3, a GRIP CAPS switch 144 controls operation of the cap gripper motor 98. An OPEN switch 148 provides for simultaneous operation of the vial motors 78 in a first direction. A CLOSE switch 152 provide for simultaneous operation of the vial motors 78 in a second direction.

A liquid crystal display (LCD) 156 is coupled to the PCB 54 and in communication with the microcontroller 50. The LCD 156 provides the user with an indication of, for example, operating modes, parameters and status of the vial handling apparatus 10.

Referring to FIG. 1, the base assembly 140 includes an external housing 160. A user interface 164 is coupled to the external housing. The LEDs pairs 86, 108, 120, switches 144, 148, 152, and display 156 (FIG. 3) are part of the user interface 164 (FIG. 1) that is coupled to the housing 160 of the base assembly 140.

With reference to FIGS. 4 and 5, a base plate 168 supports the apparatus 10 on a work surface. The power module 58 is disposed within the base assembly 140, between the base plate 168 and the controller 46.

A motor frame member 170 substantially surrounds the power module 58 and controller 46 within the housing 160. The vial motors 78 and the cap gripper motor 98 are coupled to the motor frame member 170. The motor frame member also provides a support surface 172. The support surface is configured to support a disposable cryogenic insert 174.

The insert 174 is intended to be stored frozen in sterile packaging until ready for use. The cryogenic insert 174 is filled with a cryogenic media such as a phase changing material that changes phase in the 0° C. to 4° C. temperature range. The cryogenic insert 174 defines eighteen vial apertures 176. The number and arrangement of the eighteen vial apertures 176 corresponds to the number and arrangement of apertures in an industry standard controlled freeze rate container. In other constructions of the invention, different numbers and arrangements of vial apertures may be provided. For example, other constructions of the invention may include cryogenic inserts that define more or fewer vial apertures. The vial apertures may be arranged in other patterns including, for example, a rectangular array or multiple concentric rings of apertures.

The insert 174 is intended to maintain biological samples contained in the cryovials at a temperature of about 0 to about 4° C. during the filling process prior to freezing, as mentioned above. Biological samples may be single cells, cell lines, eukaryotic cells, bacterial cells, viruses, and macromolecules, such as nucleic acids, proteins, cellular components, and tissue samples. Cells may be cord-blood cells, stem cells, embryonic stem cells, adult stem cells, cancer stem cells, progenitor cells, autologous cells, isograft cells, allograft cells, xenograft cells, and genetically engineered cells. The cells may be induced progenitor cells. The cells may be cells isolated from a subject, e.g., a donor subject, which have been transfected with a stem cell associated gene to induce pluripotency in the cells. The cells may also be any mammalian cells, such as any human cells, primary cells isolated from any tissue or organ (e.g., connective, nervous, muscle, fat or epithelial tissue), mesenchymal cells, ectodermal cells, endodermal cells, lymphocytes, B cells, T cells, cytotoxic T cells, natural killer T cells, regulatory T cells, T helper cells, myeloid cells, granulocytes, basophil granulocytes, eosinophil granulocytes, neutrophil granulocytes, hypersegmented neutrophils, monocytes, macrophages, reticulocytes, platelets, mast cells, thrombocytes, megakaryocytes, dendritic cells, thyroid cells, thyroid epithelial cells, parafollicular cells, parathyroid cells, parathyroid chief cells, oxyphil cells, adrenal cells, chromaffin cells, pineal cells, pinealocytes, glial cells, glioblasts, astrocytes, oligodendrocytes, microglial cells, magnocellular neurosecretory cells, stellate cells, boettcher cells, pituitary cells, gonadotropes, corticotropes, thyrotropes, somatotrope, lactotrophs, pneumocyte, type I pneumocytes, type II pneumocytes, Clara cells, goblet cells, alveolar macrophages, myocardiocytes, pericytes, gastric cells, gastric chief cells, parietal cells, goblet cells, paneth cells, G cells, D cells, ECL cells, I cells, K cells, S cells, enteroendocrine cells, enterochromaffin cells, APUD cell, liver cells, hepatocytes, Kupffer cells, bone cells, osteoblasts, osteocytes, osteoclast, odontoblasts, cementoblasts, ameloblasts, cartilage cells, chondroblasts, chondrocytes, skin cells, hair cells, trichocytes, keratinocytes, melanocytes, nevus cells, muscle cells, myocytes, myoblasts, myotubes, adipocyte, fibroblasts, tendon cells, podocytes, juxtaglomerular cells, intraglomerular mesangial cells, extraglomerular mesangial cells, kidney cells, kidney cells, macula densacells, spermatozoa, sertoli cells, leydig cells, oocytes, cells isolated from a diseased tissue, e.g., a cancer. Cells lines of any of the cells disclosed herein may also be used.

Referring to FIG. 4, each of the vial apertures 176 defines a vial axis 180. The vial motors 78 are each oriented along a respective vial axis 180, such that the number of vial motors corresponds to the number of vial apertures. Referring to FIG. 8, a vial cog member 184 is coupled to a motor shaft 188 of each vial motor 78. Referring to FIGS. 4 and 5, the vial motor 78 is mounted below the supports surface 172, while the vial cog member 184 is mounted above the support surface 172.

A vial drive member 192 is disposed within each respective vial aperture 176 of the insert 174 and is rotatable about the respective vial axis 180. Referring to FIG. 6, a base portion 196 of each vial drive member defines a cog recess 200 for receiving the vial cog member 184 (FIG. 8). Referring to FIG. 7, each vial drive member 192 defines a vial receptacle 204 for receiving a vial body (e.g, the vial body 18 of FIG. 2). The vial receptacle may be sized or otherwise configured for receiving specific vial body sizes and configurations (e.g., 0.5 mL to 5 mL cryovials, such as 0.5 mL, 1.0 mL, 1.5 mL, 2.0 mL, 4.0 mL, 5.0 mL, 6.0 ml, 7.0 ml, 8.0 ml, 9.0 ml or other size cryovials). The preferred vial volumetric size is 2.0 ml, 3.0 ml, 4.0 ml or 5.0 ml. The vial receptacle 204 defines an internal spline 208. The internal spline 208 is configured to matingly engage with the external spline 42 of the vial body 18.

Referring to FIG. 4, the cap gripper motor 98 is coupled to cap gripper assembly 136 via a drive shaft 212 disposed within base assembly 140.

The cap gripper assembly 136 includes an upper cover 216 and a lower cover 220. Referring to FIG. 10, the lower cover 220 defines eighteen cover apertures 240, in the same pattern and arrangement as the vial apertures 176 of the cryogenic insert 174. In other embodiments, more or fewer cover apertures may be provided, depending on the number and arrangement of the vial apertures.

Referring to FIG. 9, a cap gripper insert 244 is coupled to the lower cover 220. The cap gripper insert 244 is formed of a flexible, elastomeric material (e.g., silicone rubber) and includes a base portion 248 (FIG. 9) and eighteen pairs of flexible cap extensions 252 (FIG. 10). Each pair of cap extensions 252 defines a cap receptacle 256 for receiving and selectively gripping a vial cap 22 (FIG. 2). In other embodiments, more or fewer flexible cap extension pairs may be provided, or the cap extension pairs may be provided in different arrangements, depending on the number and arrangement of the flexible cap extensions.

Referring to FIG. 9, a cam disc 260 is disposed between the lower cover 220 and the cap gripper insert 244. The cam disc 260 is rotatably coupled to the cap gripper insert 244 and the lower cover 220 for rotation about a central axis 264 with respect to the cap gripper insert 244 and the lower cover 220. Referring to FIG. 11, the cam disc 260 defines eighteen cam apertures. More specifically, the cam disc defines twelve outer cam apertures 268 and six inner cam apertures 272. The outer cam apertures 268 are elongated, whereas the inner cam apertures 272 are substantially circular. The difference in configuration between the inner cam apertures 272 and the outer cam apertures 268 is due to their difference in radial position relative to the central axis 264 (FIG. 9). In other embodiments, more or fewer cam apertures may be provided, or the cam apertures may be provided in different arrangements, depending on the number and arrangement of the flexible cap extensions.

The cam apertures 268 and 272 are arranged to receive the cap extensions 252 of the cap gripper insert 244. When the cam disc 260 is rotated about the central axis 264, the inner cam apertures 272 and the outer cam apertures 268 place sideways force on each vial cap 22 (FIG. 2) by compressing the cap extensions (FIG. 9) to hold the vial caps within the cap receptacles 256 (FIG. 10). The size difference between the inner cam apertures 272 and outer cam apertures 268 (FIG. 11) provides for gripping all of the vial caps 22 with substantially equal gripping force as the cam disc 260 rotates.

Referring to FIG. 11, a biasing tab 280 extends from an outer radial surface 282 of the cam disc 260. Referring to FIG. 9, the cam disc 260 is rotatably biased to a non-gripping position by a resilient biasing member 284 (e.g., a coil spring) coupled to the biasing tab 280 and to the upper housing 216. The upper housing 216 is illustrated as transparent in FIGS. 9 and 10 to show internal structure, including a biasing recess 288 for accommodating the biasing tab 280 and the biasing member 284.

A stop tab 292 extends from the outer radial surface 282 of the cam disc 260, substantially opposite the biasing tab 280. The stop tab 292 is received by a stop recess 296 defined in the upper cover 216. The stop recess 296 and stop tab 292 arrangement defines circumferential travel limits the cam disc 260.

Referring to FIG. 11, the outer radial surface 282 of the cam disc 260 also includes gear teeth 302 defining a rack 306. Referring to FIG. 9, the rack 306 engages a pinion gear 310 that is selectively coupled to the drive shaft 212 of the base assembly 140, such that the cap gripper motor 98 may drivingly rotate the cam disc 260 via the shaft 212 and pinion gear 310.

Referring to FIG. 11, the outer radial surface 282 further defines ratchet teeth 314. The cam disc 260 is locked into its active gripping state using a pawl 318 that is pivotally coupled to the lower cover 220 and interfaces with the ratchet teeth 316. The pawl 318 is spring biased, and may be released by the user by actuating a release lever 322. Disengaging the pawl 318 from the ratchet teeth 314 causes the cam disc 260 to return to its biased position, and thereby releasing the vial assemblies 26 from the cap gripper assembly 136 to unload the vials into a controlled freeze rate container.

### EXAMPLE

Operation begins when a user separates the cap gripper assembly 136 from the base assembly 140 of the vial handling apparatus 10. If required, the user places a new cryogenic insert 174 in the base housing, thereby coupling the vial drive members 192 with the vial cog members 184 of the vial motors 78.

The user then loads up to eighteen vial assemblies 14 (vial body 18 and vial cap 22) into the eighteen vial drive members 192 of the cryogenic insert 176. In other words, the user may insert as few vial assemblies as required, up to the number of available vial receptacles 204. The user then replaces the cap gripper assembly 136 on the base assembly, thereby connecting the drive shaft 212 of the base assembly 140 to the pinion gear 310 of the cap gripper assembly 136 and closing the cover switch 132.

Next, the user presses the GRIP CAPS switch 144. In response to pressing the GRIP CAPS switch 144, the cap gripper motor 98 is operated to rotate the cam disc 260, such that the vial caps 22 are engaged and held by the cap extensions 252 of the cap gripper insert 244. The microcontroller 50 monitors the motor current and actuation time of the cap gripper motor 98 to ensure that in-range values are observed, resulting in illumination of the green LED 116.

Next, the microcontroller 50 verifies which, if not all, of the vial receptacles 204 are occupied by a vial assembly 14. This is done by the microcontroller operating the eighteen vial motors 78 in a first direction, thereby attempting to tighten the vial caps 22 to the vial bodies 18, briefly, at all eighteen locations. The controller then attempts to unscrew the vial caps 22 by operating the vial motors 78 in a second direction and monitoring the non-stall motor current for each vial motor 78 to ensure an in-range unwind period.

The user observes the results of the occupancy check on the user interface 164. Illuminated green vial LEDs 94 indicate vial receptacles 204 that are occupied by a vial assembly 14 and that have been successfully uncapped. Illuminated red vial LEDs 90 indicate vial receptacles 204 that are occupied, but where a vial assembly 14 has failed to uncap. An off vial LED pair 86 indicates a vial receptacle 204 where no vial assembly 14 is present. Once a controller has determined that all present vial assemblies have been uncapped, the green central LED 128 will illuminate to indicate that the user may advance to the next stage.

Next, the user separates the cap gripper assembly 136 from the base assembly 140, with the cap gripper assembly 136 retaining the vial caps 22, thereby exposing the uncapped vial bodies 18 seated within the cryogenic insert 174. The user may now dispense stem cells or other biological matter into the vial bodies 18.

Once dispensing is complete, the user replaces cap gripper assembly 136 on the base assembly 140, thereby again connecting the drive shaft 212 of the base assembly 140 to the pinion gear 310 of the cap gripper assembly 136 and closing the cover switch 132.

Next, the microcontroller 50 operates the vial motors 78 corresponding to occupied vial receptacles 204 to couple and tighten all vial caps 22 to their respective vial bodies 18. The microcontroller monitors travel time of the vial motors 78 to stall timeout, and thereby verifies that each vial assembly 14 is successfully closed. The user interface again indicates the status of each of the vial assemblies 14. A green LED 94 indicates a successful closure. A blinking red LED 90 indicates missing or unsuccessful closure. LEDs that are off again indicate vial receptacles that are unoccupied. When all vials assemblies are successfully capped and fully closed, the central green LED 128 will again illuminate green. If any vial assembly has failed to be capped and fully closed, the central red LED 124 will blink and the audible alarm 130 will sound to notify the user.

Next, the user again separates the cap gripper assembly 136 from the base assembly 140, thereby lifting all of the filled vial assemblies 14 out of the vial receptacles 204. The user may then place the cap gripper assembly 136 over a controlled freeze rate container that has been prepared for a freeze cycle, aligning the vial assemblies 14 with vial receptacles of the controlled freeze rate container. The user may then release the vial assemblies 14 from the cap gripper assembly 136 to the controlled freeze rate container by actuating the pawl release lever 322. Once the vial assemblies 14 are released, the user returns the cap gripper assembly 136 to the base assembly.

Using the disclosed apparatus, biological samples such as single cells, cell lines, stem cells, eukaryotic cells, bacterial cells, viruses, and macromolecules can be maintained at a temperature of about 0 to about 4° C. during the filling process prior to freezing, thus limiting the biological samples' exposure to freeze media outside the frozen state to a minimum.

Thus, the invention provides, among other things, a vial handling apparatus. Various features and advantages of the invention are set forth in the following claims.

What is claimed is:

1. An apparatus for the simultaneous capping and uncapping of a plurality of vial assemblies, each of the vial assemblies including a vial body and a vial cap, the apparatus comprising:
a base;
a cryogenic insert detachably coupled to the base and defining at least a first aperture about a first axis and a second aperture about a second axis, the first aperture configured to receive a first vial body, and the second aperture configured to receive a second vial body, the cryogenic insert including a cryogenic media;
a first drive member engaging the first vial body for rotation about the first axis;
a second drive member engaging the second vial body for rotation about the second axis; and
a cap gripper assembly selectively coupled to the base, the cap gripper assembly selectively holding a first vial cap in substantial alignment with the first axis and a second vial cap in substantial alignment with the second axis, such that the first drive member may selectively couple the first vial body to the first vial cap, and the second drive member may couple the second vial body to the second vial cap.

2. The apparatus of claim 1, further comprising first motor coupled to the first drive member, and a second motor coupled to the second drive member.

3. The apparatus of claim 1, wherein the first drive member defines an internal spline for engaging a portion of the first vial body.

4. The apparatus of claim 1, wherein the first drive member is at least partially disposed within the first aperture.

5. The apparatus of claim 1, wherein the first drive member includes a cylindrical body defining a receptacle for receiving the first vial body.

6. The apparatus of claim 5, wherein a base portion of the receptacle defines an internal spline for engaging the first vial body.

7. The apparatus of claim 1, wherein the cap gripper assembly includes a gripper defining a first flexible receptacle and a second flexible receptacle, and an actuator for selectively moving the receptacles between substantial engagement and substantial disengagement with the vial caps.

8. The apparatus of claim 1, wherein the cryogenic media includes a phase-change material.

9. The apparatus of claim 1, further comprising:
a first motor drivingly coupled to the first drive member;
a second motor drivingly coupled to the second drive member;
a third motor drivingly coupled to the cap gripper assembly; and
a controller controlling and monitoring operation of the first motor, the second motor, and the third motor.

10. The apparatus of claim 9, wherein the controller monitors a run time of the first motor.

11. A method of handling a plurality of vial assemblies within a capping apparatus, each vial assembly having a vial body and a vial cap and the capping apparatus including a base assembly, a cap gripper assembly, and a cryogenic insert including a plurality of receptacles, the method comprising:
coupling the cryogenic insert to the base assembly;
placing each of the vial assemblies within one of the receptacles;
coupling the cap gripper assembly to the base assembly;
gripping the vial cap of each vial assembly with the cap gripper assembly;
rotating each of the vial bodies to separate the vial bodies from the respective vial cap; and
separating the cap gripper assembly from the base assembly, the cap gripper assembly retaining the plurality of vial caps.

12. The method of claim 11, wherein rotating each of the vial bodies includes rotating each of the receptacles about an axis with a motor.

13. The method of claim 11, further comprising providing a plurality of motors, each motor coupled to a respective receptacle for rotating the receptacle about a respective axis.

14. The method of claim 11, further comprising coupling each receptacle to a respective motor.

15. The method of claim 11, further comprising coupling the cap gripper assembly to the base assembly, the cap gripper assembly retaining the plurality of vial caps

16. The method of claim 15, further comprising rotating each of the vial bodies to couple the vial bodies with the respective vial caps.

17. The method of claim 16, further comprising separating the cap gripper assembly from the base assembly, the cap gripper assembly retaining the plurality of vial assemblies.

18. The method of claim 11, wherein coupling the cap gripper assembly to the base assembly includes connecting a drive shaft of the base assembly to the cap gripper assembly.

19. The method of claim 18, wherein gripping the vial cap of each vial assembly with the cap gripper assembly includes rotating the drive shaft.

20. An apparatus for the simultaneous capping and uncapping of a plurality of vial assemblies, each of the vial assemblies including a vial body and a vial cap, the apparatus comprising:
a base defining at least a first aperture about a first axis and a second aperture about a second axis, the first aperture configured to receive a first vial body, and the second aperture configured to receive a second vial body;
a first drive member engaging the first vial body for rotation about the first axis;
a second drive member engaging the second vial body for rotation about the second axis; and
a cap gripper assembly selectively coupled to the base, the cap gripper assembly selectively holding a first vial cap in substantial alignment with the first axis and a second vial cap in substantial alignment with the second axis, such that the first drive member may selectively couple the first vial body to the first vial cap, and the second drive member may couple the second vial body to the second vial cap.
